(19) United States
(12) Patent Application Publication
(10) Pub. No.: US 2011/0004542 A1
(43) Pub. Date: Jan. 6, 2011

(54) ARTICLE SALES DATA PROCESSING APPARATUS AND CAPITAL INVESTMENT INCREASE METHOD

(75) Inventor: Makiko Terabayashi, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/825,604

(22) Filed: Jun. 29, 2010

(30) Foreign Application Priority Data
Jul. 3, 2009 (JP) 2009-158841
Jun. 4, 2010 (JP) 2010-128996

(51) Int. Cl. G06Q 40/00; G06Q 30/00

(52) U.S. Cl. 705/37

(57) ABSTRACT

According to one embodiment, an article sales data processing apparatus includes an investor specifying unit, an acquisition unit, and an addition unit. The investor specifying unit accepts an input of investor identification information to identify an investor. The acquisition unit acquires information about capital investment stored in association with the investor identification information accepted by the specifying unit. The addition unit adds a differential amount between a total amount of an article sold in one transaction and a deposit amount for a price of the articles, to the capital investment acquired by the acquisition unit.

### CROSS-REFERENCE TO RELATED APPLICATIONS

This application is based upon and claims the benefit of priority from Japanese Patent Applications No. 2009-158841, filed Jul. 3, 2009; and No. 2010-128996, filed Jun. 4, 2010; the entire contents of both of which are incorporated herein by reference.

### FIELD

Embodiment described herein relate generally to an article sales data processing apparatus which is provided in a store operated by an association organization that provides group purchasing services of daily commodities as its business and which processes the payment of the price of an article purchased by an investor who finances the association organization.

### BACKGROUND

An example of an association organization that provides group purchasing services of daily commodities including food, daily necessities and clothing is a consumer cooperative. Generally, in a consumer cooperative, an investor who finances the cooperative is registered as a member and a member card is issued to each member.

The capital investment from each member is used to lay in articles and enrich other facilities. Each business year, if there is a current account surplus, dividends are given to members in accordance with the amount of money invested. Therefore, many members properly increase their capital investment after the admission to the cooperative.

In a store operated by the consumer cooperative, only a member who presents a member card can buy articles. In the store of the consumer cooperative, an apparatus to process the payment of articles purchased by an investor who finances the association organization is installed.

### BRIEF DESCRIPTION OF THE DRAWINGS

FIG. 1 is a block diagram showing the overall configuration of a POS system.

FIG. 2 shows the data structure of a capital investment record stored in an investor management file of a member management server.

FIG. 3 is a block diagram showing the main configuration of a POS terminal.

FIG. 4 shows a keyboard of the POS terminal.

FIG. 5 shows main memory areas formed in a RAM of the POS terminal.

FIG. 6 is a flowchart showing main procedures for registration of one transaction carried out by a CPU of the POS terminal in a first embodiment.

FIG. 7 is a flowchart showing main procedures for capital investment increase executed by the CPU of the POS terminal in the first embodiment.

FIG. 8 shows an example of a message displayed on a customer-side display device of the POS terminal in the first embodiment.

FIG. 9 shows an example of a message displayed on the customer-side display device of the POS terminal in the first embodiment.

FIG. 10 shows an example of a message displayed on the customer-side display device of the POS terminal in the first embodiment.

FIG. 11 is a flowchart showing procedures for capital investment account management executed by the member management server in the first embodiment.

FIG. 12 shows an example of a receipt issued from the POS terminal in the first embodiment.

FIG. 13 is a flowchart showing main procedures for registration of one transaction carried out by the CPU of the POS terminal in a second embodiment.

FIG. 14 is a flowchart showing main procedures for capital investment increase executed by the CPU of the POS terminal in the second embodiment.

FIG. 15 is a schematic view showing an example of a message displayed on the customer-side display device of the POS terminal in the second embodiment.

FIG. 16 is a flowchart showing main procedures for registration of one transaction carried out by the CPU of the POS terminal in a third embodiment.

FIG. 17 is a schematic view showing an example of a message displayed on the customer-side display device of the POS terminal in the third embodiment.

### DETAILED DESCRIPTION

In general, according to one embodiment, an article sales data processing apparatus includes an investor specifying unit, an acquisition unit, and an addition unit. The investor specifying unit accepts an input of investor identification information to identify an investor. The acquisition unit acquires information about capital investment stored in association with the investor identification information accepted by the specifying unit. The addition unit adds a differential amount between a total amount of an article sold in one transaction and a deposit amount for a price of the article, to the capital investment acquired by the acquisition unit.

In the following embodiments, the article sales data processing apparatus is applied to a POS terminal for a store operated by a consumer cooperative.

### First Embodiment

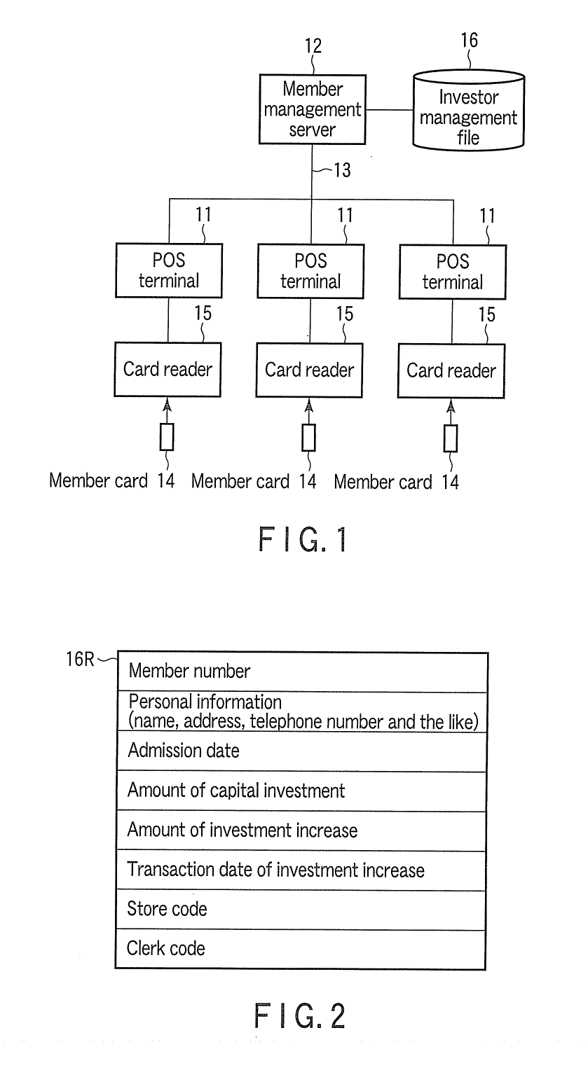

A first embodiment will be described with reference to FIG. 1 to FIG. 12.

FIG. 1 is a block diagram showing the configuration of a POS system. The POS system includes plural POS terminals 11 and a member management server 12. Each POS terminal 11 is placed at a checkout counter of a store. The member management server 12 is place, for example, in a management office of the store. The member management server 12 connects each POS terminal 11 to a communication line 13 such as LAN (local area network).

Each POS terminal 11 is connected with a card reader 15 to read data of each member card 14. The member card 14 is a portable recording medium such as magnetic card, contact IC card, or non-contact wireless IC card, in which at least a member number to specify each member is recorded. A member means an investor who finances a consumer cooperative. The member management server 12 has an investor management file 16 to save data about each member.

FIG. 2 shows the data structure of a member record 16R stored in the investor management file 16. The member record 16R includes items such as member number, personal information (name, address, telephone number and the like), admission date, amount of capital investment, amount of investment increase, transaction date of investment increase, store code, clerk code and the like. In the investor management file 16, the member record 16R of each member is accumulated and saved.

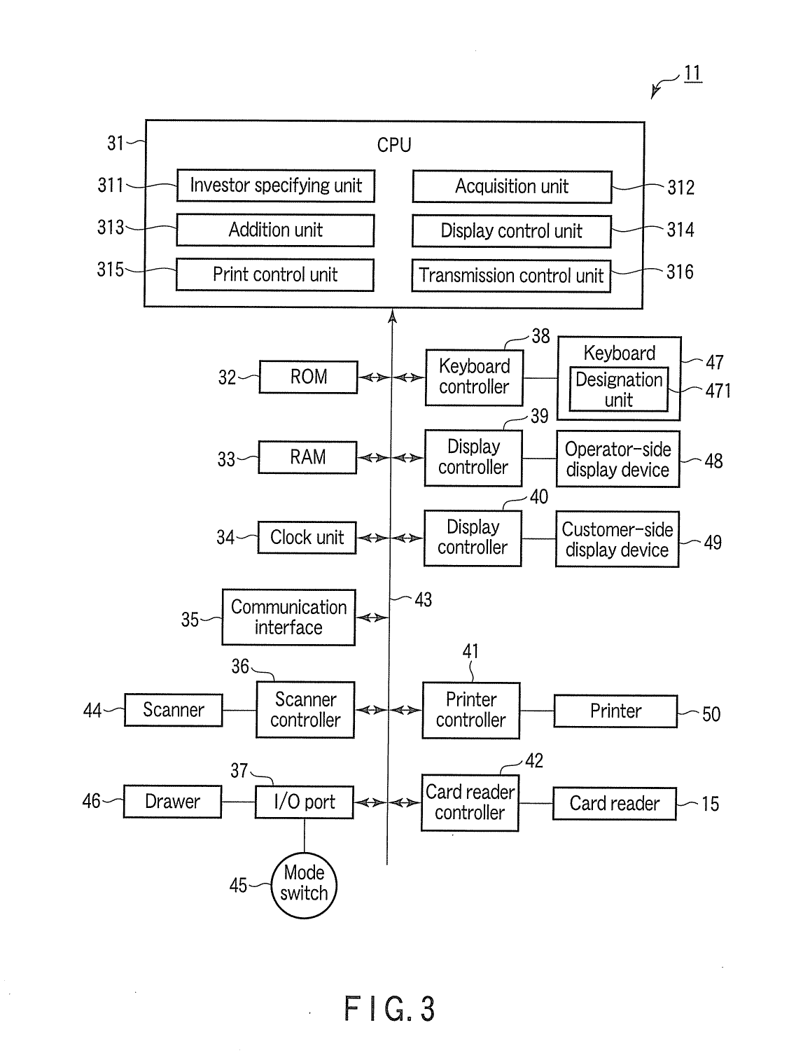

FIG. 3 is a block diagram showing the main configuration of the POS terminal 11. The POS terminal 11 has a CPU (central processing unit) 31 as a main control unit. A ROM (read only memory) 32, a RAM (random access memory) 33, a clock unit 34, a communication interface 35, a scanner controller 36, an I/O (input-output) port 37, a keyboard controller 38, a first display controller 39, a second display controller 40, a printer controller 41 and a card reader controller 42 are connected to the CPU 11 via a bus line 43 such as address bus or data bus.

The communication interface 35 controls data communication between the POS terminal 11 and the member management server 12.

The scanner controller 36 controls a scanner 44 and takes in barcode data scanned by the scanner 44. The scanner 44 optically scans a barcode attached to an article bought by a member.

The I/O port 37 inputs a signal from a mode switch 45. The I/O port 37 also outputs a driving signal to a drawer 46 in response to a command from the CPU 31. The drawer 46 is provided to house cash or the like and automatically opens in response to the input of the driving signal. The drawer 46 may also have an automatic change function.

The mode switch 45 selects various operation modes such as “registration”, “inspection” and “checkout” and commands the CPU 31 to execute the selected mode. The mode switch 45 is switched, for example, by a key.

If the “registration” mode is selected, the POS terminal 11 mainly executes the following operations.

1. Operation to register sales data of an article to a memory on the basis of article data inputted via the scanner 44 and an input unit of a keyboard 47.

2. Operation to calculate and display the total mount based on sales data of all the articles registered in one transaction.

3. Operation to calculate and display the differential amount between a deposit amount and the total amount as an amount of change when the deposit amount is inputted from the input unit.

4. Operation to print the content of the sales data of all the articles registered in one transaction on a receipt sheet and thus issue a receipt.

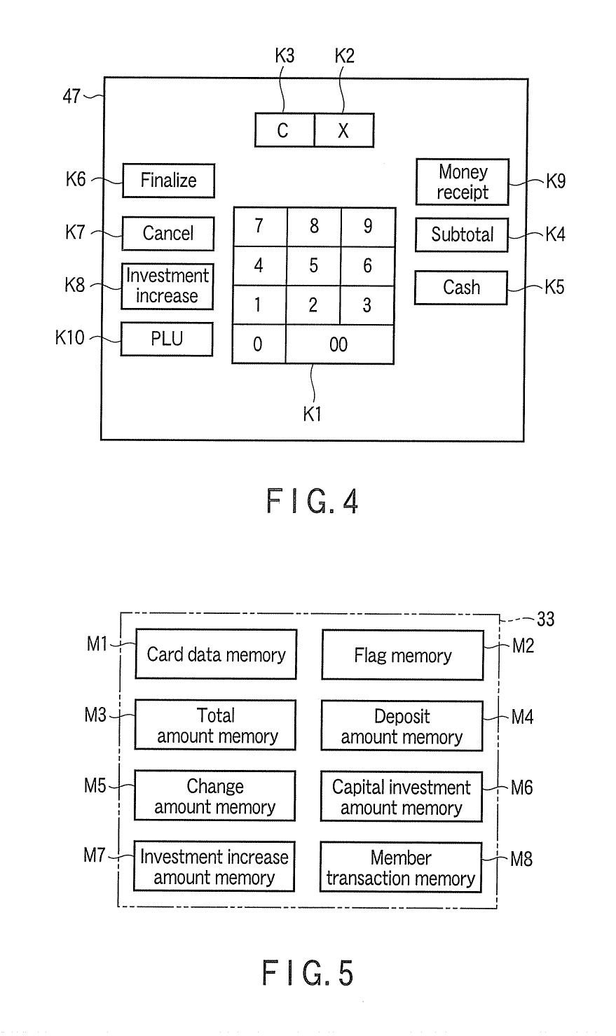

The keyboard controller 38 controls the keyboard 47 and takes in a signal corresponding to an operated key. The keyboard 47 has numeric keys K1, a multiplication key K2, a clear key K3, a subtotal key K4, a CASH key K5, a finalizing key K6, a cancel key K7, an investment increase key K8, a money receipt key K9, a PLU key K10 and the like, as shown in FIG. 4.

The CASH key K5 has a function as a registration closing key to declare that the price of one transaction is paid by cash. The investment increase key K8 has a function as a key to declare that capital investment is increased via the amount of change. The finalizing key K6 has a function as a key to declare that the amount of investment increase is finalized.

The first display controller 39 controls an operator-side display device 48 and causes information for a cashier as an operator to be displayed on the screen of the display device 48. The second display controller 40 controls a customer-side display device 49 and causes information for a member to be displayed on the screen of the display device 49. The printer controller 41 controls a printer 50 to print data on a receipt sheet and causes the printer 50 to issue a receipt. The card reader controller 42 controls the card reader 15 and accesses data of the member card 14 read by the card reader 15.

FIG. 5 is a schematic view showing main memory areas formed in the RAM 33. A card data memory M1 stores the data of the member card 14 read by the card reader 15. A flag memory M2 stores a member transaction flag. The member transaction flag is set to “1” when a transaction with a member is carried out.

A total amount memory M3 stores the total amount of articles bought by the member in one transaction. A deposit amount memory M4 stores the deposit amount that is the amount paid by the member in the one transaction. A change amount memory M5 stores the amount of change calculated by subtracting the total amount from the deposit amount.

A capital investment amount memory M6 stores the amount of capital investment by the member. An investment increase amount memory M7 stores the amount of investment increase by the member. A member transaction memory M8 stores the item name of articles bought by the member, the amount of sales, the number of items sold, the total amount, the deposit amount, the amount of change and the like.

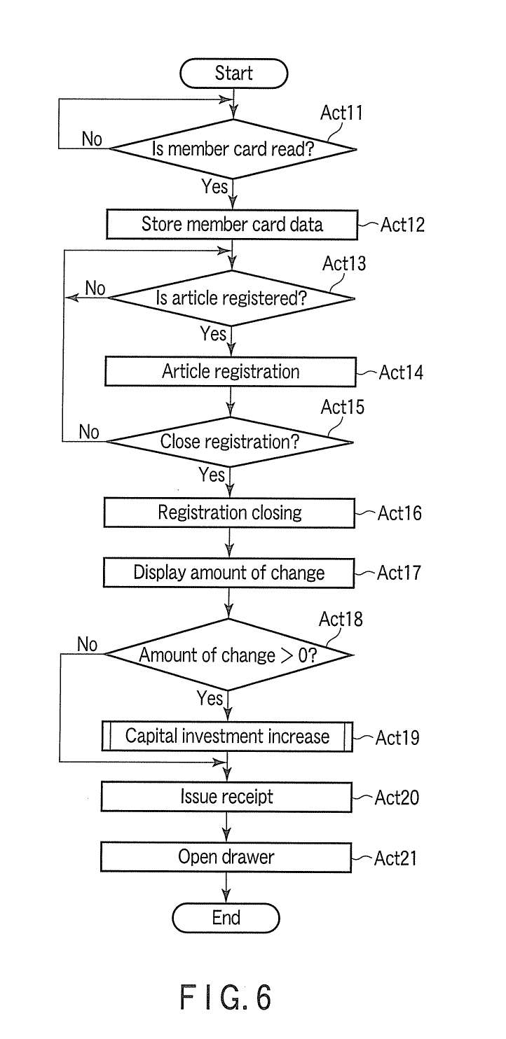

If the “registration” mode is selected by the mode switch 45, the CPU 31 controls the transaction with the member according to the procedures shown in the flowchart of FIG. 6. The procedures are controlled by a program stored in the ROM 32.

First, the CPU 31 waits for the data of the member card 14 to be read (ACT 11). When the data of the member card 14 is read by the card reader 15 (YES in ACT 11), the CPU 31 writes the card data into the card data memory M1 (ACT 12; an investor specifying unit 311).

Next, the CPU 31 waits for an article purchased by the member to be registered (ACT 13). When the barcode on the article is scanned by the scanner 44 or the article code is inputted by the operation of the numeric keys K1 and the PLU key K10, the article is registered. When the article is registered (YES in ACT 13), the CPU 31 executes article registration (ACT 14).

In this article registration, the CPU 31 reads out article information including item name, unit price and the like that is preset in an article master file corresponding to the inputted article code, and multiplies the unit price by the number of items sold to calculate the amount of sales. Then, the CPU 31 stores article sales data including the article code, the item name, the amount of sales, the number of items sold and the like into the member transaction memory M8. The CPU 31 also causes the operator-side display device 48 and the customer-side display device 49 to display the item name of the registered article, the amount of sales and the like.

Next, the CPU 31 determines whether the closing of the registration of the article is declared or not (ACT 15). If the closing of the registration is not declared (NO in ACT 15), the CPU 31 waits for the next article to be registered (ACT 13). That is, the CPU 31 repeats the article registration every time an article is registered during a period until the closing of the registration is declared after the member card 14 is read. Consequently, sales data of all the articles bought by one member is stored in the member transaction memory M8.

If the CASH key K5 is inputted, the closing of the registration of the article is declared. If the closing of the registration is declared (YES in ACT 15), the CPU 31 execute registration closing (ACT 16).

In this registration closing, the CPU 31 calculates the total amount based on the article sales data stored in the member transaction memory M8. The CPU 31 then writes the data of the total amount into the total amount memory M3. If a deposit amount greater than the total amount is inputted via the numeric keys K1 immediately before the CASH key K5 is inputted, the CPU 31 writes the data of the deposit amount into the deposit amount memory M4. If no deposit amount is inputted, the CPU 31 writes the data of the total amount into the deposit amount memory M4.

Next, the CPU 31 subtracts the total amount in the total amount memory M3 from the deposit amount in the deposit amount memory M4 and thus calculates the amount of change. The CPU 31 then writes the data of the amount of change into the change amount memory M5. The CPU 31 also causes the operator-side display device 48 and the customer-side display device 49 to display the amount of change (ACT 17).

Next, the CPU 31 determines whether the amount of change in the change amount memory M5 is greater than zero or not (ACT 18). If the amount of change is greater than zero (YES in ACT 18), the CPU 31 carries out capital investment increase (ACT 19). In this capital investment increase, the CPU 31 increases this member's capital investment using a part or all of the amount of change.

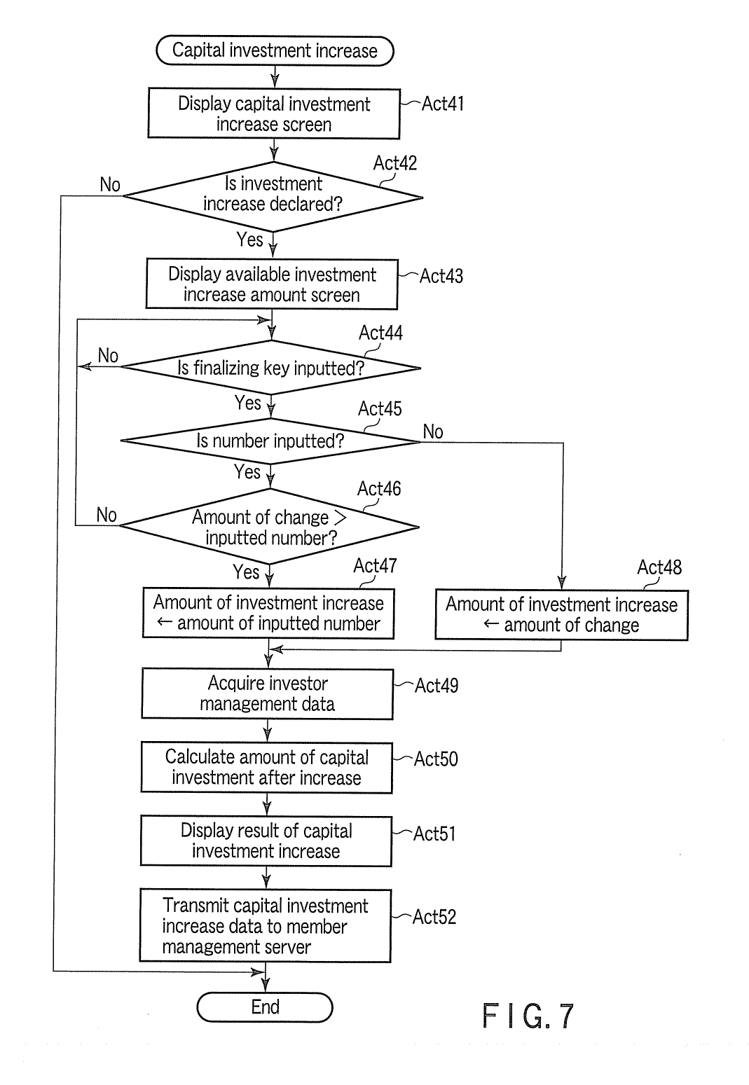

FIG. 7 is a flowchart showing main procedures for the capital investment increase. First, the CPU 31 causes the customer-side display device 49 to display a capital investment increase confirmation screen 60.

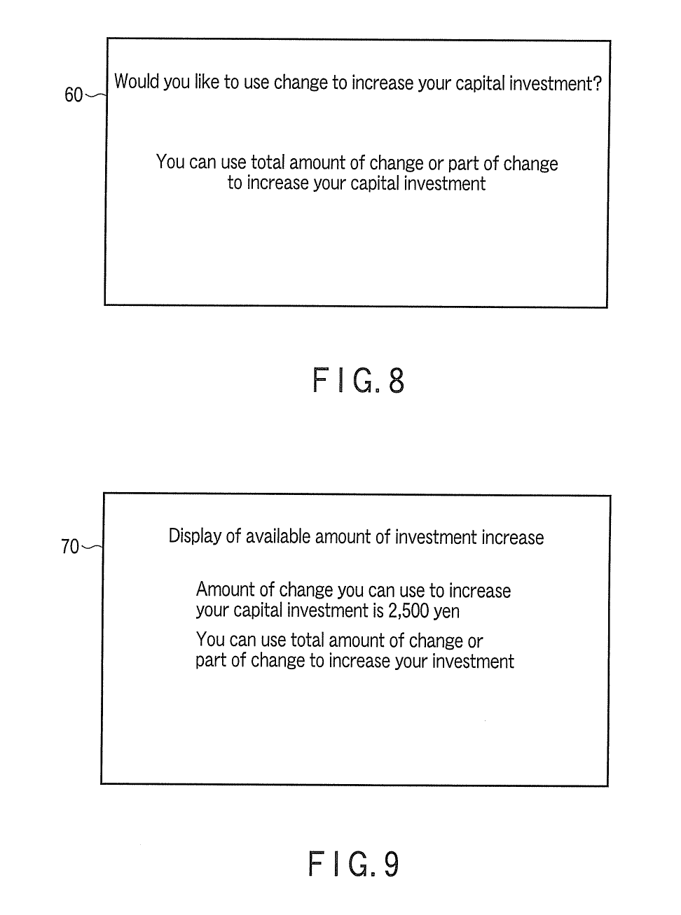

FIG. 8 shows an example of the capital investment increase confirmation screen 60. As shown in FIG. 8, in this screen 60, a message to notify the member that the amount of change can be used to increase the capital investment is displayed.

After the screen 60 is displayed, the CPU 31 waits for a declaration as to whether the amount of change is used to increase the capital investment or not (ACT 42). Here, if the cancel key K7 is inputted, the amount of change is not used to increase the capital investment. In this case (NO in ACT 42), the CPU 31 ends the capital investment increase.

On the other hand, if the investment increase key K8 is inputted, the amount of change is used to increase the capital investment. In this case (YES in ACT 42), the CPU 31 causes the customer-side display device 49 to display an available investment increase amount screen 70 (ACT 43).

FIG. 9 shows an example of the available investment increase amount screen 70. As shown in FIG. 9, in this screen 70, a message to notify the member of the available amount to be used for capital investment increase is displayed. FIG. 9 shows the available investment increase amount screen 70 for a member having the amount of change of 2,500 yen.

After the screen 70 is displayed, the CPU 31 waits for an amount of investment increase for the capital investment to be designated via a designation unit 471 of the keyboard 47 (ACT 44). The designation unit 471 includes the numeric keys K1 and the finalizing key K6.

That is, if the finalizing key K6 is inputted (YES in ACT 44), the CPU 31 determines whether a number is inputted or not by the numeric keys K1 (ACT 45). If a number is not inputted (No in ACT 45), the CPU 31 determines that the total amount of change is designated as the amount of investment increase. The CPU 31 copies the data of the amount of change in the change amount memory M5 to the investment increase amount memory M7 (ACT 48).

On the other hand, if a number is inputted (YES in ACT 45), the CPU 31 determines whether the number data is smaller than the data of the amount of change in the change amount memory M5 or not (ACT 46). If the number data is equal to or greater than the data of the amount of change (NO in ACT 46), the CPU 31 waits for input of an amount of investment increase again (ACT 44).

If the number data is smaller than the change amount data (YES in ACT 46), the CPU 31 determines that a part of the amount of change is designated as the amount of investment increase. The CPU 31 writes the number data into the investment increase amount memory M7 (ACT 47).

As the processing of ACT 47 or ACT 48 is finished, the CPU 31 acquires investor management data of that member (ACT 49; an acquisition unit 312).

Specifically, the CPU 31 acquires a member number included in the card data in the card data memory M1. The CPU 31 then generates an inquiry command for investor management data including this member number and transmits the inquiry command to the member management server 12 via the communication interface 35.

After receiving the inquiry command, the member management server 12 searches the investor management file 16, using the member number included in the command, and thus accesses the member record 16R on which the same member number is set. This member record 16R is then sent back to the POS terminal 11 of the inquiry source via the communication line 13.

After receiving the response data (investor management data) of the member record 16R from the member management server 12, the CPU 31 extracts data of the amount of capital investment from the response data and writes the extracted data into the capital investment amount memory M6. The CPU 31 then adds the amount of investment increase in the investment increase amount memory M7 to the data in the capital investment amount memory M6 and thus calculates the amount of capital investment after the investment increase (ACT 50; an addition unit 313).

Next, the CPU 31 causes the operator-side display device 48 and the customer-side display device 49 to display a capital investment increase result screen 80 (ACT 51; a display control unit 314).

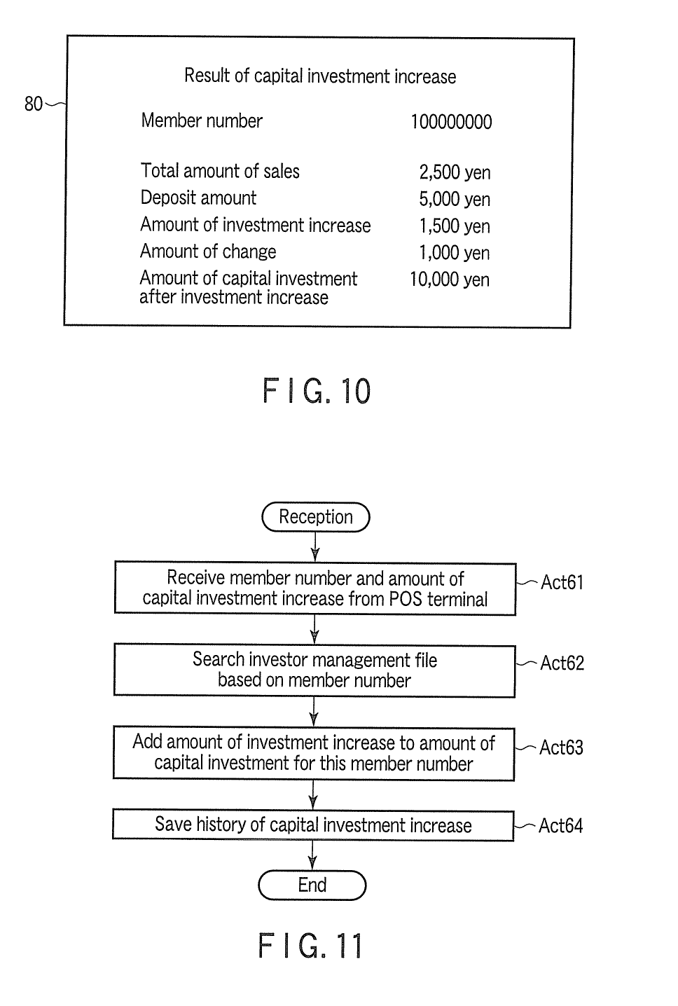

FIG. 10 shows an example of the capital investment increase result screen 80. As shown in FIG. 10, in the screen 80, the member number, the total amount of sales, the deposit amount, the amount of investment increase, the amount of change, the amount of capital investment after the investment increase and the like are displayed. FIG. 10 shows the case where a member having the amount of capital investment of 8,500 yen before a transaction makes a purchase equivalent to the total amount of 2,500 yen, pays 5,000 yen for the price, and uses 1,500 yen as a part of the amount of change of 2,500 yen to increase the capital investment.

After the screen 80 is displayed, the CPU 31 creates capital investment increase data including the member number and the amount of investment increase. The CPU 31 then transmits this data to the member management server 12 via the communication interface 35 (ACT 52; a transmission control unit 316). Then, the capital investment increase ends.

Referring again to FIG. 6, if the amount of change is zero (NO in ACT 18) or if the capital investment increase is finished, the CPU 31 generates print data for a receipt. The print data is generated on the basis of the data in the member transaction member M8, the total amount memory M3, the deposit amount memory M4, the change amount memory M5, the capital investment amount memory M6 and the investment increase amount memory M7. The CPU 31 outputs the print data to the printer 50 and controls the issue of a receipt 90 (ACT 20; a print control unit 315).

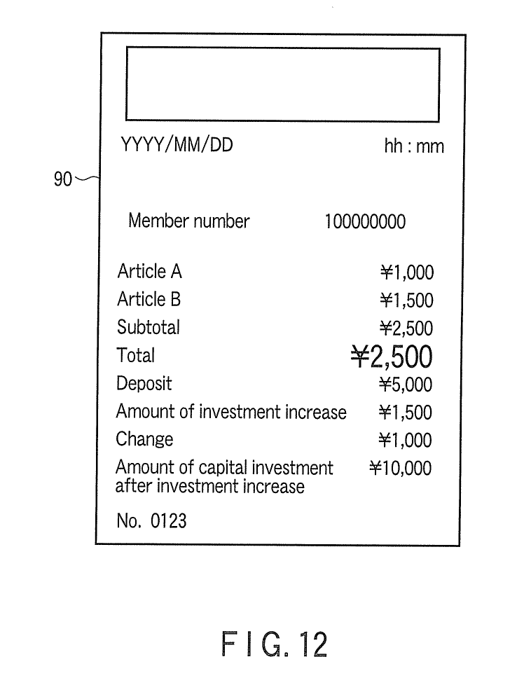

FIG. 12 shows an example of the receipt 90. As shown in FIG. 12, in the receipt 90, the data in the member transaction memory M8, that is, detail data including the item name of the article bought by the member, the amount of sales, the subtotal amount, the amount of tax and the like, is printed. The total amount data in the total amount memory M3, the deposit amount data in the deposit amount memory M4, the change amount data in the change amount memory M5, the capital investment amount data in the capital investment amount memory M6 and the investment increase amount data in the investment increase amount memory M7 are printed as well.

After the receipt is issued, the CPU 31 controls the opening of the drawer 46 (ACT 21). Then, the transaction with the member is finished.

FIG. 11 is a flowchart showing procedures to receive the capital investment increase data in the member management server 12.

As the server 12 receives the capital investment increase data from the POS terminal 11 via the communication line 13, the server 12 acquires the member number and the amount of capital investment increase from the capital investment increase data (ACT 61). The server 12 then searches the investor management file 16, using the member number (ACT 62).

When the member record 16R having the same member number is detected in the investor management file 16, the CPU 31 adds the data of the amount of investment increase acquired from the capital investment increase data to the capital investment amount data in the member record 16R (ACT 63). The CPU 31 also updates the data of the transaction date of investment increase in the member record 16R to the date data of that day (ACT 64).

According to the first embodiment, it is possible to use the amount of change generated in one transaction by a member, to increase the capital investment.

### Second Embodiment

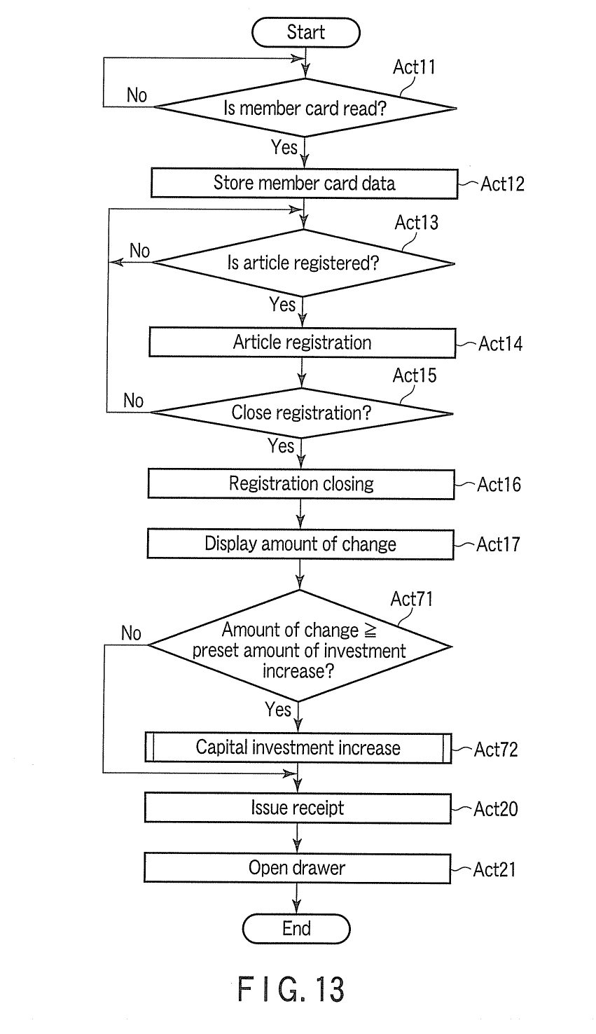

A second embodiment will be described with reference to FIG. 13 to FIG. 15. The same parts as in the first embodiment are denoted by the same reference numerals and will not be described further in detail.

FIG. 13 is a flowchart showing procedures to control a transaction with a member that is executed by the CPU 31 in the second embodiment. In the first embodiment, the CPU 31 executes capital investment increase if there is an amount of change (see ACT 18 and ACT 19 in FIG. 6). In the second embodiment, when the amount of change is equal to or greater than a preset amount, the CPU 31 executes the capital investment increase equivalent to that amount or greater (see ACT 71 and ACT 72 in FIG. 13).

That is, after causing the operator-side display device 48 and the customer-side display device 49 to display the amount of change (ACT 17), the CPU 31 determines whether or not the amount of change in the change amount memory M5 is equal to or greater than a preset amount of investment increase (ACT 71). The preset amount of investment increase is greater than zero and is preset in the RAM 33.

If the amount of change is equal to or greater than the preset amount of investment increase (YES in ACT 71), the CPU 31 executes the capital investment increase (ACT 72). If the amount of change is smaller than the preset amount of investment increase (NO in ACT 71), the capital investment increase is not executed.

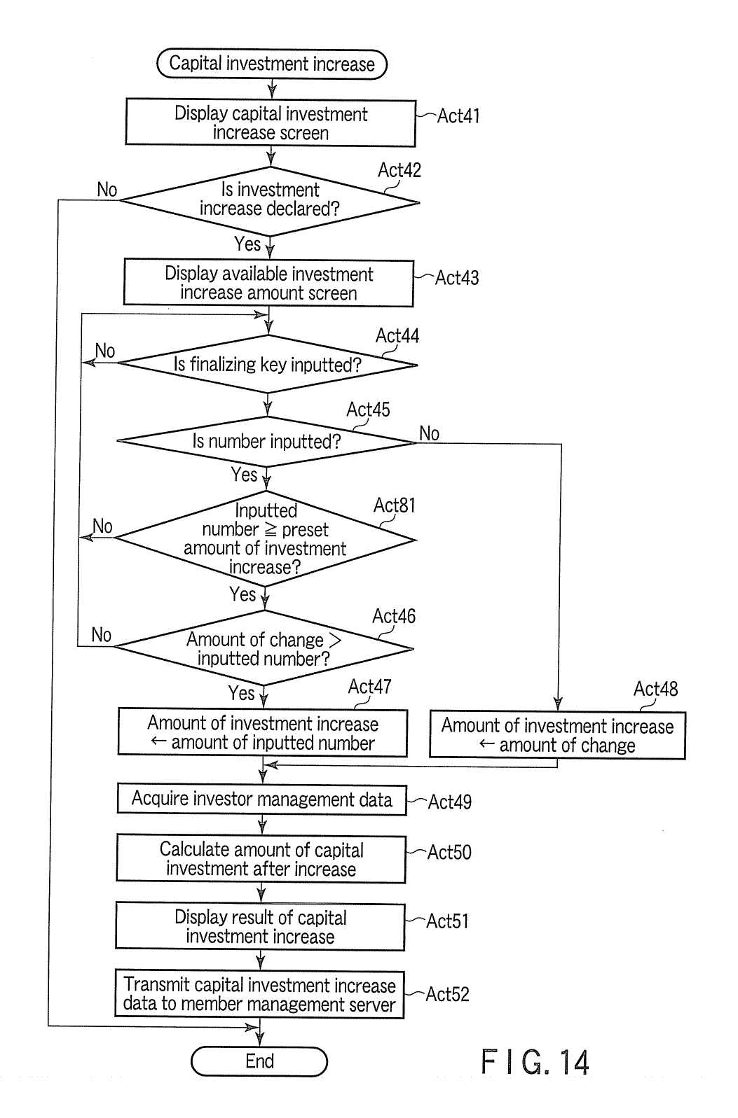

FIG. 14 is a flowchart showing main procedures for the capital investment increase in the second embodiment. In the first embodiment, when the finalizing key K6 is inputted (YES in ACT 45) in the state where a number is inputted via the numeric keys K1, the CPU 31 determines whether the number data is smaller than the change amount data in the change amount memory M5 or not (ACT 46). In the second embodiment, before the determination in ACT 46, the CPU 31 determines whether or not the number data is equal to or greater than the preset amount of investment increase (ACT 81). If the number data is smaller than the preset amount of investment increase (NO in ACT 81), the CPU 31 waits for input of an investment amount again (ACT 44).

If the number data is equal to or greater than the preset amount of investment increase (YES in ACT 81), the CPU 31 determines whether the number data is smaller than the change amount data in the change amount memory M5 or not (ACT 46). The subsequent procedures are similar to those in the first embodiment.

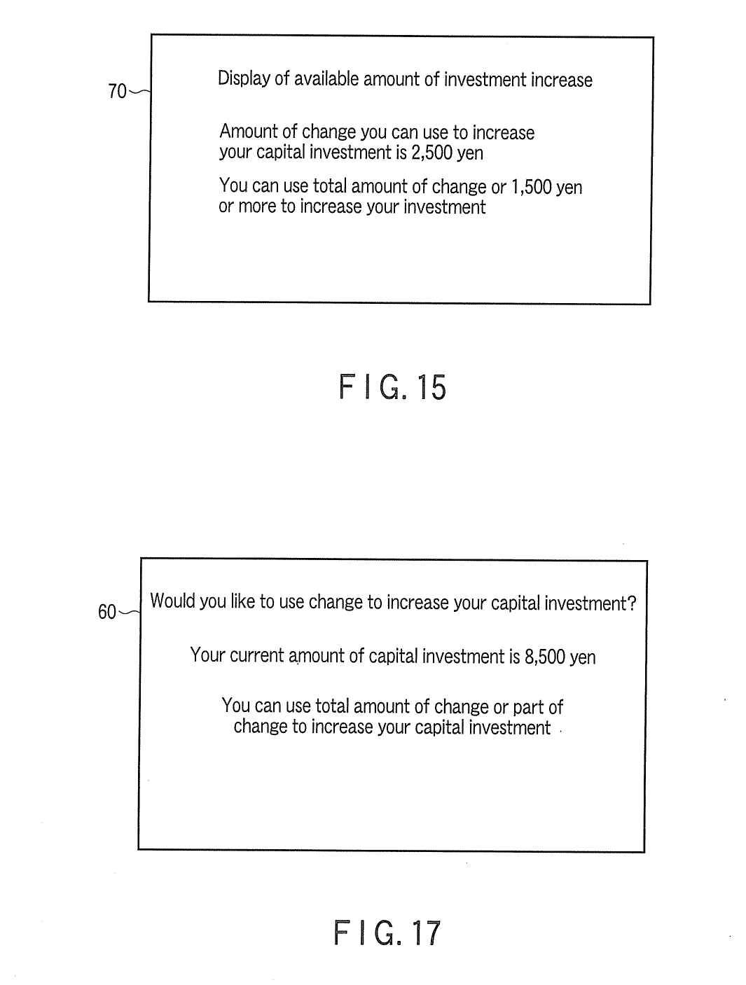

FIG. 15 shows an example of the available investment increase amount screen 70 displayed on the customer-side display device 49 in the second embodiment. FIG. 15 shows the available investment increase screen 70 to a member having the amount of change of 2,500 yen where the preset amount of investment increase is set to 1,500 yen. As shown in FIG. 15, in the available investment increase amount screen 70, a message to notify that the total amount of change or the preset amount of investment increase of 1,500 yen or more can be used for investment increase is displayed.

In the second embodiment, since investment increase less than the preset amount of investment increase cannot be carried out, there is no investment increase by a small amount. Therefore, it becomes easier to manage capital investment.

### Third Embodiment

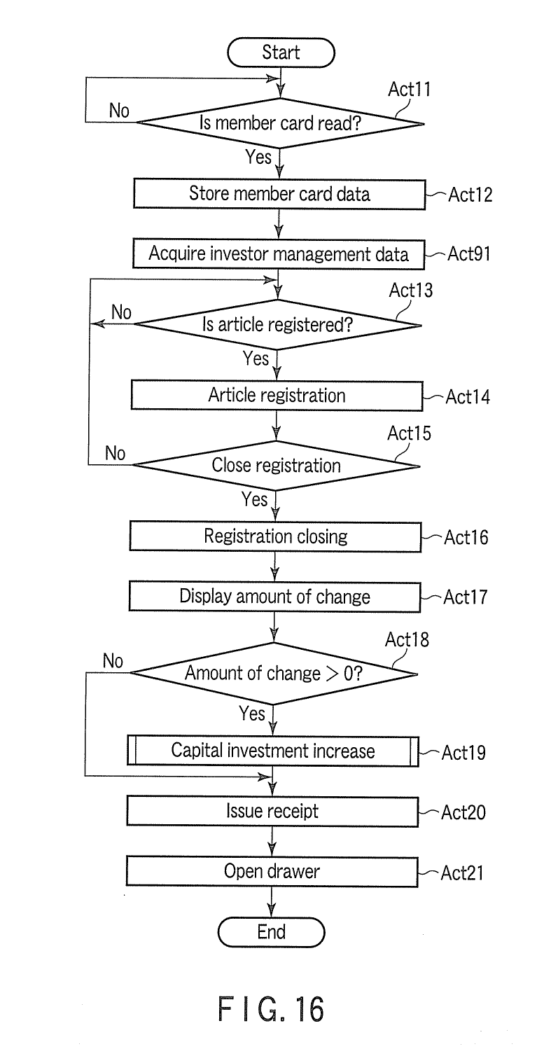

A third embodiment will be described with reference to FIG. 16 and FIG. 17. The same parts as in the first embodiment are denoted by the same reference numerals and will not be described further in detail.

FIG. 16 is a flowchart showing procedures to control a transaction with a member that is executed by the CPU 31 in the third embodiment. In the first embodiment, the CPU 31 acquires the investor management data of the member after the amount of investment increase is finalized (see ACT 47, ACT 48 and ACT 49 in FIG. 7). In the third embodiment, the investor management data of the member is acquired after the data of the member card 14 is read by the card reader 15 (see ACT 11, ACT 12 and ACT 91 in FIG. 16).

The subsequent processing is similar to that in the first embodiment or the second embodiment.

FIG. 17 shows an example of the capital investment increase confirmation screen 60 displayed on the customer-side display device 49 in the third embodiment. As shown in FIG. 17, in the screen 60, a message to notify the member that the amount of change can be used to increase the capital investment, and the amount of capital investment by the member before the investment increase are displayed.

In the third embodiment, the investor management data of the member is acquired when the data of the member card 14 is read by the card reader 15. Therefore, by displaying the amount of capital investment by the member before the investment increase in the capital investment increase confirmation screen 60, it is possible to notify the member of the current amount of capital investment before the investment increase.

Thus, according to the embodiments, if a member uses the total amount of change to increase the capital investment, there is no need to receive change. Also, if the member designates a fraction of change as part of the amount of change and uses the designated amount to increase investment, there is no need to receive small change.

In the embodiments, the cashier carries out an operation as to whether the amount of change is used to increase investment or not. However, for example, the customer-side display device 49 may be configured as a touch panel display and the member may carry out this operation by himself or herself.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An article sales data processing apparatus comprising:
an investor specifying unit which accepts an input of investor identification information to identify an investor;
an acquisition unit which acquires information about an amount of capital investment stored in association with the investor identification information accepted by the specifying unit; and
an addition unit which adds a differential amount between a total amount of an article sold in one transaction and a deposit amount for a price of the article, to the amount of capital investment acquired by the acquisition unit.

2. The apparatus of claim 1, further comprising a designation unit which designates an amount of investment increase for the amount of capital investment,
wherein when the amount of investment increase designated by the designation unit is equal to or smaller than the differential amount, the addition unit adds the amount of investment increase to the amount of capital investment acquired by the acquisition unit.

3. The apparatus of claim 1, further comprising:
a display control unit which causes a display unit to display the amount of capital investment after investment increase that is calculated by the addition unit.

4. The apparatus of claim 1, further comprising a print control unit which prints the amount of capital investment after investment increase that is calculated by the addition unit, on a receipt on which details of the article sold in the one transaction are printed.

5. The apparatus of claim 1, further comprising a transmission control unit which transmits the amount of capital investment after investment increase that is calculated by the addition unit together with the investor identification information accepted by the specifying unit, to a server which manages a data file storing information about the amount of capital investment in association with the investor identification information of each investor.

6. An article sales data processing apparatus comprising:
an investor specifying unit which accepts an input of investor identification information to identify an investor;
an acquisition unit which acquires information about an amount of capital investment stored in association with the investor identification information accepted by the specifying unit; and
an addition unit which, when a differential amount between a total amount of an article sold in one transaction and a deposit amount for a price of the article is equal to or greater than a preset amount that is greater than zero, adds the differential amount to the amount of capital investment acquired by the acquisition unit.

7. The apparatus of claim 6, further comprising a designation unit which designates an amount of investment increase for the amount of capital investment,
wherein when the amount of investment increase designated by the designation unit is equal to or greater than the preset amount and equal to or smaller than the differential amount, the addition unit adds the amount of investment increase to the amount of capital investment acquired by the acquisition unit.

8. The apparatus of claim 6, further comprising:
a display control unit which causes a display unit to display the amount of capital investment after investment increase that is calculated by the addition unit.

9. The apparatus of claim 6, further comprising a print control unit which prints the amount of capital investment after investment increase that is calculated by the addition unit, on a receipt on which details of the article sold in the one transaction are printed.

10. The apparatus of claim 6, further comprising a transmission control unit which transmits the amount of capital investment after investment increase that is calculated by the addition unit together with the investor identification information accepted by the specifying unit, to a server which manages a data file storing information about the amount of capital investment in association with the investor identification information of each investor.

11. A capital investment increase method for an article sales data processing apparatus, the method comprising:
the article sales data processing apparatus
accepting, by a specifying unit, an input of investor identification information to identify an investor;
acquiring, by an acquisition unit, information about an amount of capital investment stored in association with the investor identification information accepted by the specifying unit; and
adding a differential amount between a total amount of an article sold in one transaction and a deposit amount for a price of the article, to the capital investment acquired by the acquisition unit.
